(19) United States
(12) Patent Application Publication
(10) Pub. No.: US 2010/0223214 A1
(43) Pub. Date: Sep. 2, 2010

(54) AUTOMATIC EXTRACTION USING MACHINE LEARNING BASED ROBUST STRUCTURAL EXTRACTORS

(76) Inventors: Alok S. Kirpal, Sunnyvale, CA (US); Sandeepkumar Bhuramal Satpal, Bangalore (IN); Meghana Kshirsagar, Bangalore (IN); Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/395,586

(22) Filed: Feb. 27, 2009

(51) Int. Cl. G06F 15/18

(52) U.S. Cl. 706/12

(57) ABSTRACT

A method and apparatus for automatically extracting information from a large number of documents through applying machine learning techniques and exploiting structural similarities among documents. A machine learning model is trained to have at least 50% accuracy. The trained machine learning model is used to identify information attributes in a sample of pages from a cluster of structurally similar documents. A structure-specific model of the cluster is created by compiling a list of top-K locations for each attribute identified by the trained machine learning model in the sample. These top-K lists are used to extract information from the pages of the cluster from which the sample of pages was taken.

### CROSS REFERENCE TO RELATED APPLICATIONS

This application is related to U.S. patent application Ser. No. 12/346,483, filed on Dec. 30, 2008, entitled “APPROACHES FOR THE UNSUPERVISED CREATION OF STRUCTURAL TEMPLATES FOR ELECTRONIC DOCUMENTS”, the entire content of which is incorporated by reference for all purposes as if fully disclosed herein.

This application is related to U.S. patent application Ser. No. 11/481,734, filed on Jul. 5, 2006, entitled “TECHNIQUES FOR CLUSTERING STRUCTURALLY SIMILAR WEB PAGES”, the entire content of which is incorporated by reference for all purposes as if fully disclosed herein.

This application is related to U.S. patent application Ser. No. 11/481,809, filed on Jul. 5, 2006, entitled “TECHNIQUES FOR CLUSTERING STRUCTURALLY SIMILAR WEB PAGES BASED ON PAGE”, the entire content of which is incorporated by reference for all purposes as if fully disclosed herein.

This application is related to U.S. patent application Ser. No. 11/945,749, filed on Nov. 27, 2007, entitled “TECHNIQUES FOR INDUCING HIGH QUALITY STRUCTURAL TEMPLATES FOR ELECTRONIC DOCUMENTS”, the entire content of which is incorporated by reference for all purposes as if fully disclosed herein.

This application is related to U.S. patent application Ser. No. 12/036,079, filed on Feb. 22, 2008, entitled “BOOSTING EXTRACTION ACCURACY BY HANDLING TRAINING DATA BIAS”, the entire content of which is incorporated by reference for all purposes as if fully disclosed herein.

This application is related to U.S. patent application Ser. No. 12/013,289, filed on Jan. 11, 2008, entitled “EXTRACTING ENTITIES FROM A WEB PAGE”, the entire content of which is incorporated by reference for all purposes as if fully disclosed herein.

### FIELD OF THE INVENTION

The present invention relates to information extraction and, more specifically, to automatically extracting information from a large number of documents through applying machine learning techniques and exploiting structural similarities among documents.

### BACKGROUND

The Internet is a worldwide system of computer networks and is a public, self-sustaining facility that is accessible to tens of millions of people worldwide. The most widely used part of the Internet is the World Wide Web, often abbreviated “www” or simply referred to as just “the web”. The web is an Internet service that organizes information through the use of hypermedia. Various markup languages such as, for example, the HyperText Markup Language (“HTML”) or the “eXtensible Markup Language (“XML”), are typically used to specify the content and format of hypermedia documents (e.g., web pages). In this context, a markup language document may be a file that contains source code for a particular web page. Typically, a markup language document includes one or more pre-defined tags with content either enclosed between the tags or included as an attribute of the tags.

The information presented in web pages can be logically grouped into entities comprised of information attributes. For example, FIG. 1 illustrates web page 100 with information about a product, i.e., a car. The information about the car presented in web page 100 can be logically grouped into a product entity, with the attributes of title 101, image 102, price 103, description 104, and user rating 105. As a further example, web page 200 of FIG. 2 displays information about a hotel entity with the attributes of name 201, address 202, rating 203, room rate 204, and image 205.

Today, a plethora of web portals and sites are hosted on the Internet in diverse fields like e-commerce, boarding and lodging, and entertainment. The information entities presented by any particular web site are usually presented in a uniform format to give a uniform look and feel to the web pages therein. The uniform appeal is usually achieved by using the same script to generate web pages. A web page consists of static and dynamic content. The dynamic content is pulled from a database and presented at a fixed location on the web page. Thus, extracting information from web pages requires identifying the information attributes corresponding to entities on the pages, and extracting and indexing the attributes relevant to those entities. Information extraction from such sites becomes important for applications, such as search engines, requiring extraction of information from a large number of web portals and sites. Thus, Information Extraction (IE) systems are used to gather and manipulate unstructured and semi-structured information from a variety of sources, including web sites and other collections of documents used to disseminate information. Three examples of IE systems are (1) rules-based systems, (2) machine-learning systems, and (3) wrapper-induction systems.

One method of extracting information from documents is rules-based. This type of IE system utilizes a set of rules, typically written by a human, that encodes knowledge about the structure of web pages in general. The purpose of these rules is to indicate how to identify attributes on any given page. Such rules may be effective in identifying attributes in a small sample of pages, for example, hundreds of thousands of pages. However, it is difficult to formulate a set of rules to cover all of the structures of information found in large samples of pages, for example, hundreds of millions of pages. Thus, a rules-based system may extract accurate information from a small number of related documents conforming to a structure assumed by the rules, but generally fails to extract accurate information from a variety of web pages with varying structures. For a simple example, a particular rules-based system contains a rule stating that anything near a dollar sign ($) is a price. When applied to sample web page 100 of FIG. 1, the rule would correctly extract “$21,500,” “$27,810,” “$19,888,” and “$25,307” as prices 103. However, the rule would fail to extract prices on other web pages that are not expressed in dollars, i.e., pounds (£). Also, if a page contains a description of a product entity that includes the phrase “Will save you $$$!,” the rule would extract “$$$!” as a price, which is clearly erroneous. Furthermore, a rules-based system may be able to extract attributes from web pages, but such systems generally do not recognize that the attributes pertain to an entity. Thus, it is difficult to correctly aggregate into entities those attributes extracted by a rules-based system.

Another type of IE system is a machine-learning model. A machine learning model uses machine learning principles to learn the characteristics of a set of documents annotated to be training data. The annotations found in the documents of training data generally consist of information attributes that have been labeled by type. For example, web page 300 in FIG. 3 illustrates a non-limiting example of a document in a training data set. Attributes of page 300 have been labeled based on the type of each attribute, i.e., title 311, image 312, price 313, description 314, and user rating 315. Such attribute labels can be produced, i.e., by a human, or by a rules-based IE system, etc. The set of training documents is usually very small compared to the set of documents from which the model will extract data because training data is costly to create. Thus, because it is difficult to scale training data, it is difficult to scale the scope of what a machine-learning model can recognize as attributes on a page. However, a machine learning model can accurately construct entities from attributes. If the training data input to a machine learning model has both annotated attributes, and annotated entities to which the attributes pertain, then the model can ascertain a graphical structure to represent the dependencies between the attributes of the entities. Thus, machine learning models can learn, from the training data, which attributes should be grouped together to form an entity. When such a model is run on a multi-entity page, the model can associate extracted attributes with the correct logical entity.

A third example of IE systems are wrapper induction systems, also called simply “wrappers.” Wrappers learn a template representing the structure of a cluster of structurally similar documents, referred to herein as a “cluster.” While wrappers model the structure of the pages of a cluster with relatively high precision, wrappers do not have information about where attributes exist in the structure of the documents. To remedy this deficiency of wrappers, a set of training pages can be annotated by a human to inform the wrapper about the location of attributes in the various training pages, as described above in connection with page 300 of FIG. 3. This information on the location of attributes is then generalized to the wrapper template. Because wrappers function based on the structure of a cluster, the wrapper approach generally has a high precision, but is also structure-specific. Therefore, according to this described method of wrapper induction, a wrapper template and human-annotated training data must be developed for every cluster of structurally similar pages. Thus, in order to extract information from two separate clusters, generally, a wrapper is written for each cluster and also a human annotates training sets for each respective cluster.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 and 2 illustrate example web pages;

FIG. 3 illustrates an example web page that has been annotated;

FIG. 4 is a flowchart illustrating a general overview of an embodiment of the invention;

FIG. 5 is a flowchart illustrating determination of a structure-specific model according to an embodiment of the invention;

FIG. 6 is a block diagram that illustrates a DOM tree structure for an example web page;

FIG. 7 is a flowchart illustrating extraction of information from a document using a structure-specific model according to an embodiment of the invention;

FIG. 8 is a flowchart illustrating combination of the output of a structure-specific model and a machine learning model according to an embodiment of the invention; and

FIG. 9 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

One embodiment of the invention provides a robust model for extraction by using a machine learning model to initialize a structure specific extraction model. This embodiment of the invention improves extraction precision by reinforcing structural information within a set of structurally homogeneous pages. In this embodiment of the invention, the structure specific model is trained on a sample of structurally homogenous pages and is used to extract information on the same set of structurally homogenous pages. As such, this embodiment of the invention automatically trains a cluster-wise high accuracy extractor without any human intervention by limiting the training and testing of the extractor to clusters of structurally homogenous pages.

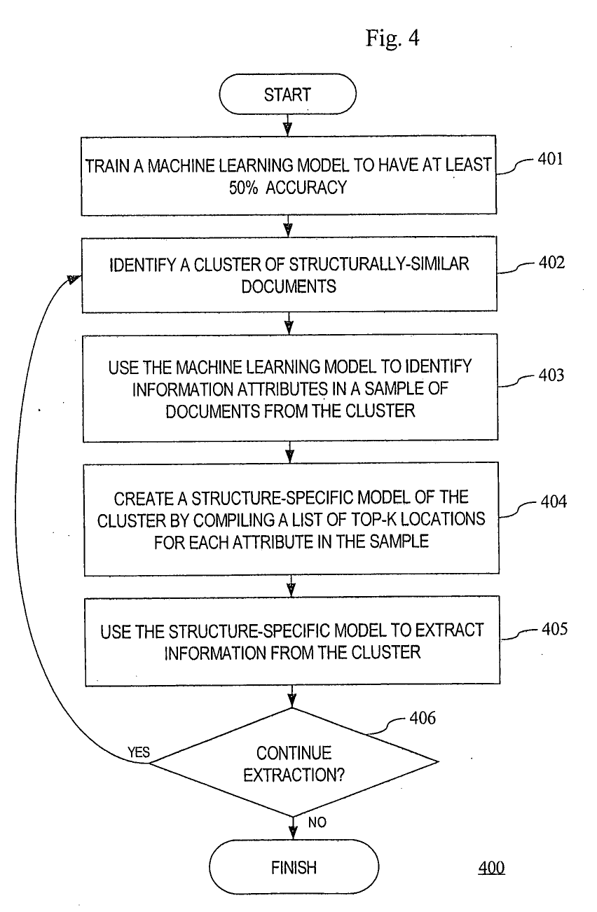

In one embodiment of the invention illustrated in FIG. 4, a machine learning model, such as a Conditional Random Field (CRF) model, is trained on a sufficiently large set of training data in order for the model to have at least 50% accuracy, step 401. A cluster of structurally similar documents are identified, step 402, and the trained machine learning model is used to identify information attributes in a sample set of pages from the cluster, step 403. A structure-specific model of the cluster is created by compiling a list of top-K locations for each attribute identified by the trained machine learning model in the sample set, step 404. These top-K lists are used to extract information from the pages of the cluster from which the sample of pages was taken, step 405. A structure-specific model is created for each cluster of structurally similar pages, i.e., if extraction is to continue at step 406, then the process cycles back to step 402. A person of ordinary skill in the art will understand that the example process illustrated in FIG. 4 is non-limiting, and the embodiments of the invention could be practiced using different steps in a different order than that shown in FIG. 4.

The trained machine learning model is relatively inexpensive because of the low requirement for accuracy, i.e., 50%. This trained machine learning model is used to create a structure-specific model, like a wrapper, for each cluster of structurally similar pages from which information is to be extracted. These structure-specific models are very precise without requiring human annotation of training pages for each such structure-specific model. Thus, high quality information can be extracted from a large number of documents with the minimal expense of training the machine learning model to have at least 50% accuracy.

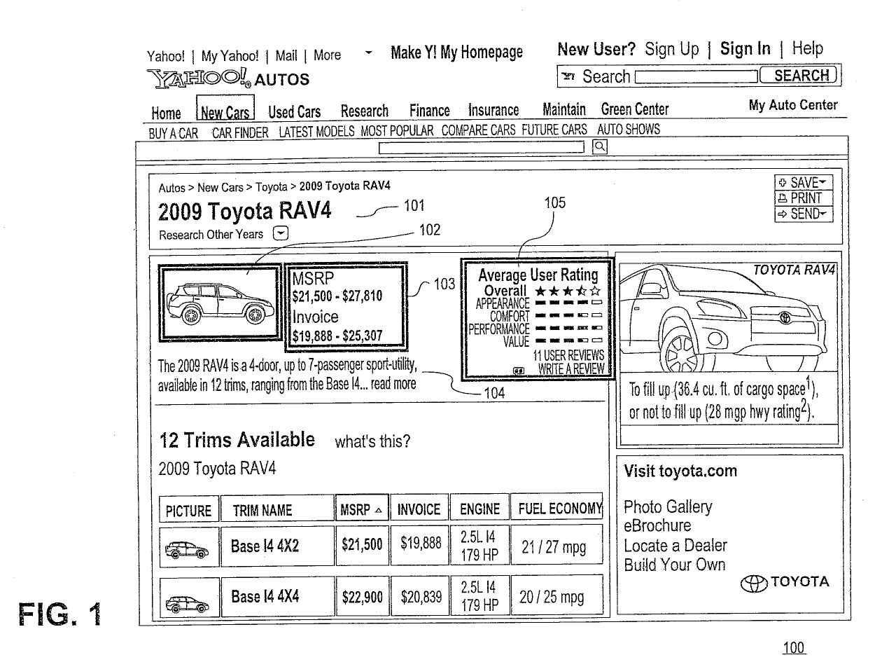

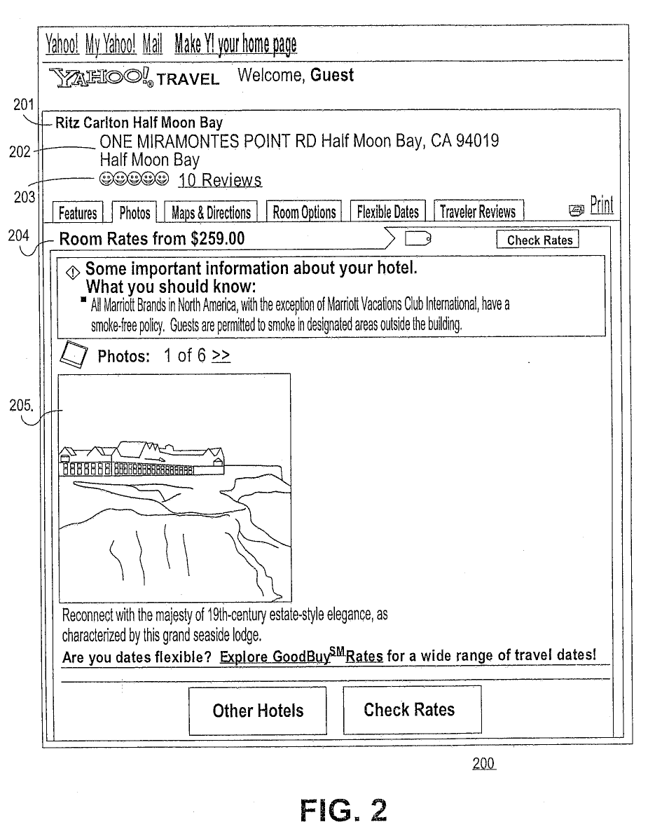

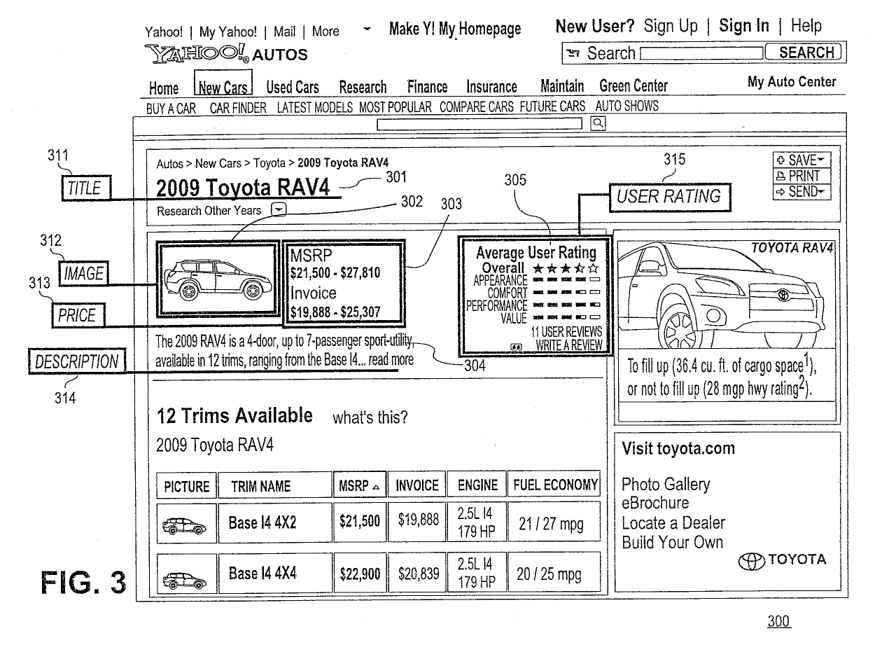

In another embodiment of the invention, structure-specific models are used to extract information from the pages of a cluster with very high precision, i.e., with 90% or above precision. Precision is defined as the ratio of the number of correct extractions to the number of total extractions. For example, if an IE system extracts from page 100 of FIG. 1 a title attribute with the value “2009 Toyota RAV4”, then the extraction is precise because that value is the true title of the car entity presented by page 100. If that title is the only information attribute extracted from page 100, then the IE system would have achieved 100% precision with respect to page 100. However, if the IE system extracts the value “12 Trims Available _{what's this?}” as the title attribute for the car entity of page 100, this is imprecise because the value is not the correct title of the car entity. In this embodiment of the invention, high precision is achieved by exploiting the structural similarities of a cluster of documents to prune out false positives candidates, i.e., “12 Trims Available _{what's this?}” in the example above.

### Machine Learning Model

In one embodiment of the invention, a machine-learning model is trained on a set of pages that is large enough to give the model an accuracy of 50% or above. A model with at least 50% accuracy will accurately extract information from pages outside of the training set at least half of the time. In the context of this embodiment of the invention, a CRF model will be discussed, but a person of ordinary skill in the art will understand that any other classification scheme that annotates and extracts information attributes from data can be used, e.g., Hidden Markov models, etc.

To train a machine learning model to have at least 50% accuracy generally requires only a few hundred training pages, which is inexpensive relative to training models at a higher accuracy, i.e., 90% or above. Furthermore, the training pages for the machine learning model need not include pages that are structurally similar to those pages from which information will be extracted by the techniques of the embodiments of this invention. As previously stated, the purpose of the machine learning model is to identify and extract information attributes from any web page. Therefore, the attributes in the training pages for the machine learning model are labeled so that the machine learning model is able to identify trends in features associated with certain types of attributes, i.e., price, title, etc. These trends are compiled in the machine learning model and are used to identify attributes in documents outside of the training set.

Conditional Random Field is a well-known machine learning technique for labeling sequential data. In order to train an extraction model, CRF receives each document of the training set and analyzes each document as a sequence of tokens, where tokens represent the leaf nodes of the Document Object Model (DOM) tree of the respective documents. Each informative token of the sequence has a label and a set of CRF-observable features associated with the token. If a token does not have a label, then the token is ignored by the CRF model. Features associated with a token in a document may be, e.g., a number of text characters in the token, inclusion of a currency symbol in the token, font size and format, color, placement, etc. CRF learns a model in terms of such observable features. For example, a CRF model may include the following characteristics: product-title of a page appears in bold text, product-price always contains a “$” or some other currency symbol, product-image has an extension “.gif,” etc. A trained machine learning model can label and extract, from previously unseen documents, those attributes identified in the model.

### Structure-Specific Model

A machine learning model trained in the manner described above does not give high precision extractions without a huge expense for training documents. The information extracted by an inexpensive machine learning model with low precision, e.g., 50% to 70%, will consist of 50% to 30% false positives, which are items of information incorrectly extracted as values for particular information attributes. For example, a false positive extraction in the context of page 100 of FIG. 1 may be extraction of “12 Trims Available _{what's this?}” as the title for the car entity presented by page 100. Thus, in one embodiment of the invention, the inexpensive machine learning model having low precision is augmented by exploiting structural similarities between web pages to increase the accuracy of information extraction by pruning out false positives candidates identified by the machine learning model.

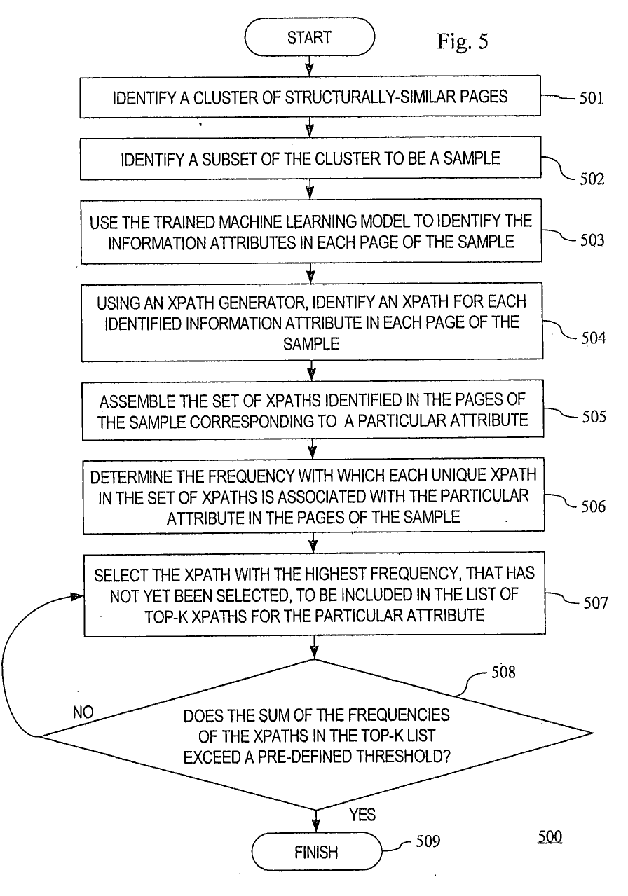

In this embodiment of the invention, as illustrated in FIG. 5, a cluster of structurally similar pages from which information is to be extracted is identified, step 501. The structural similarity of these pages allows for precise identification of trends in the structural location of attributes in the pages of the cluster. A subset of the pages in the cluster is identified to be a sample set, step 502. The trained machine learning model is used to identify information attributes of the entities on the pages of the sample, step 503. For each page in the sample, an XPath is found for each attribute identified by the machine learning model, where the XPath indicates the position of the attribute in the DOM tree of the page in which the attribute occurs. In one embodiment of the invention, an XPath generator utilizes the DOM tree of the page in which the attribute occurs to identify the XPath for the information attributes identified by the machine learning model, step 504.

XPath is a language that describes a way to locate and process items in XML documents by using an addressing syntax based on a path through the logical structure of the document, and has been recommended by the World Wide web Consortium (W3C). The specification for XPath can be found at http://www.w3.org/TR/XPath.html, and the disclosure thereof is incorporated by reference as if fully disclosed herein. Also, the W3C tutorial for XPath can be found at http://www.w3schools.com/XPath/default.asp, and the disclosure thereof is incorporated by reference as if fully disclosed herein. Given an entity in a DOM tree, various XPaths could be defined to reach the entity. For example, an XPath may indicate traversal of each of the nodes directly between the root node and the entity, or an XPath may indicate traversal from the root node of the DOM tree to the left-most child of the parent of the entity and indicate the index of the entity in the array of children of the parent. XPaths can be controlled to handle generic (non-numbered) to very specific (numbered) structures.

### Top-K XPaths

In one embodiment of the invention, as illustrated in FIG. 5, the XPaths identified in each of the sample pages for each particular attribute are assembled into sets corresponding to each attribute, step 505. For example, the XPaths identified in the pages of the sample set corresponding to a “price” attribute are assembled into a first set corresponding to “price,” and the XPaths corresponding to a “title” attribute are assembled into a second set corresponding to “title.” For purposes of explanation, it is assumed that a particular attribute in a page can be mapped to a single node in the DOM tree of the page.

In another embodiment of the invention, the XPath with the highest frequency in the sample pages is selected to be included in the structure-specific model. In yet another embodiment of the invention, the top-K XPaths for each identified attribute in the sample set are chosen to be in the structure specific model. The XPaths in the structure-specific model can be chosen to maximize either precision or recall. As previously discussed, precision deals with the correctness of information extracted, without respect to the amount of information extracted. For example, Site A has 100 total pages. Of the 100 pages in Site A, 90 pages contain a price attribute that is found at a particular XPath “<html>/<body>/<table>/<tr>/<td>[1]”, while the price in the remaining 10 pages occurs at various other XPaths. In this example, only one XPath can be used to extract information from the pages of Site A. To maximize precision, the particular XPath “<html>/<body>/<table>/<tr>/<td>[1]” can be chosen to extract “price” information from all 100 pages in the site. Because 10 of the pages in Site B do not contain the particular XPath, a price is only extracted from 90 of the pages. However, this choice of XPath maximizes precision because each attribute extracted from the 90 pages is the correct price, and the extraction would have 100% accuracy. Another option is to maximize the recall of the system by choosing an XPath that occurs in all of the pages of Site B. For example, a generalization of the particular XPath can be used, i.e., “<html>/<body>/<table>/<tr>/<td>”. This generalized XPath will likely extract information from all 100 pages in Site A, which maximizes recall, but there would be errors in the data. For example, 50% of the information extracted may actually be price information.

In an embodiment of the invention, wherein precision is maximized, the XPaths in a list of top-K XPaths for a particular attribute are chosen to be included in the structure-specific model based on the frequency with which the XPaths occur in the pages of the sample set. As such, the XPaths in a top-K list for a particular attribute collectively provide maximum coverage of the attribute in the pages of the sample set. As a non-limiting example, for each XPath in the set of XPaths for a particular attribute, assembled in step 505 of FIG. 5, a frequency is determined with which the XPath is associated with the particular attribute in the pages of the sample, step 506. The top-K XPaths for the particular attribute are chosen by including, in the set of top-K XPaths, each XPath that both has the highest frequency and which has not yet been selected to be in the list of the top-K XPaths, step 507. The list of top-K XPaths for the particular attribute is complete when the aggregate frequency of the XPaths in the list exceeds a pre-defined threshold, i.e., 90%, step 508. To illustrate, a machine learning model identifies four distinct XPaths corresponding to a particular attribute in 30 sample pages of Site B: XPath_1, XPath_2, XPath_3, and XPath_4. XPath_1 was found in 15 of the sample pages, XPath_2 was found in 13 of the sample pages, and XPath_3 and XPath_4 were each found in one of the sample pages. If the pre-defined threshold set for the aggregate frequency of the XPaths in the top-K list for the particular attribute is 90%, then XPath_1 and XPath_2 would comprise the list of top-K XPaths for the present example because the aggregate frequency of XPath_1 and XPath_2 is 93%. As illustrated by this example, the threshold for the aggregate frequency of the XPaths in a top-K list provides a mechanism to control recall without compromising precision. If only XPath_1 were used to extract the particular attribute from the pages of Site B, there would be high precision, but only an estimated 50% recall. However, by implementing a top-K list according to the embodiments of this invention, and including both XPath_1 and XPath_2 in the top-K list for the particular attribute, precision will still be high, but recall is improved to an estimated 93%.

For another example of choosing XPaths to be in a particular list of top-K XPaths based on the frequency that an XPath occurs in the pages of the sample, a particular XPath corresponding to a particular attribute is chosen to be in the list of top-K XPaths if the frequency with which the particular XPath is found in the sample set is above a pre-defined threshold. To illustrate, if the predefined threshold for a particular attribute is chosen to be 3%, then any XPath corresponding to the particular attribute found in the sample set having a frequency above 3% is included in the list of top-K XPaths for the particular attribute. A person of skill in the art will recognize that the manner of choosing a list of top-K XPaths could be varied and still be within the embodiments of the invention.

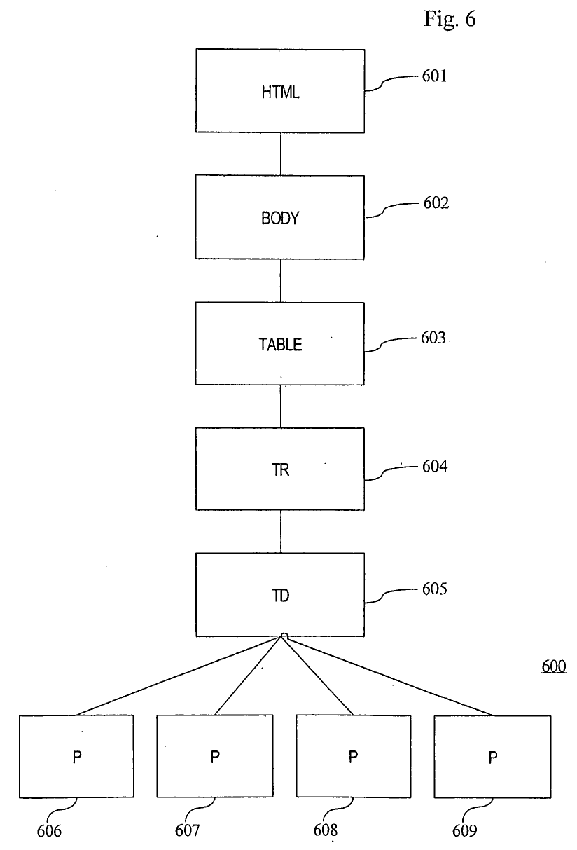

Some information attributes span multiple nodes of a DOM tree, e.g., description attributes can be found spanning multiple nodes in a page. With such attributes, multiple precise XPaths could be used to describe the location of each leaf node corresponding to the multiple-node attribute. For example, FIG. 6 illustrates a simple DOM tree structure 600 of a particular page having four P nodes 606-609 across which spans a description attribute in the particular page. In one embodiment of the invention, in the case of a multiple-node attribute such as the description attribute of nodes 606-609, the top-K XPaths learned for such an attribute is a set of partial XPaths, wherein the XPaths are generalized to identify the most specific subtree in which the nodes of the attribute are found. Thus, in the example of FIG. 6, the description attribute would not be identified by the four unique XPaths describing the locations of nodes 606-609 for the purposes of the embodiments of the invention, but the XPath for TD node 605, which is the most specific subtree identifying description nodes 606-609. Thus, for multiple-node attributes the top-K XPath set consists of partial XPaths.

Because the top-K XPaths have been learned in the context of a cluster of structurally similar pages, extraction using these XPaths is structure-specific and provides very high precision. This high precision is gained by pruning out false positives and extracting a high percentage of correct information. For example, if a sample of structurally similar pages is generated by a single script, then a particular attribute is expected to occur at the same location across the pages of the sample, i.e., the particular attribute will be associated with the same XPath across the pages of the sample. This structural similarity can be used to prune out false positive candidates for the particular attribute, because the false positive candidates will have low or no structural similarity with the correct candidates.

In order to create a structure-specific model for a different cluster, the process is repeated by applying a trained machine-learning model on a sample of pages from a different cluster of structurally similar pages and then constructing a set of lists top-K XPaths corresponding to that cluster. No human intervention is necessary to create these structure-specific models, and therefore the structure-specific models are very inexpensive. Furthermore, the cost to build a machine-learning model with at least 50% accuracy is minimal. Therefore, the embodiments of this invention provide an inexpensive and easily scalable information extraction technique.

### Data Extraction

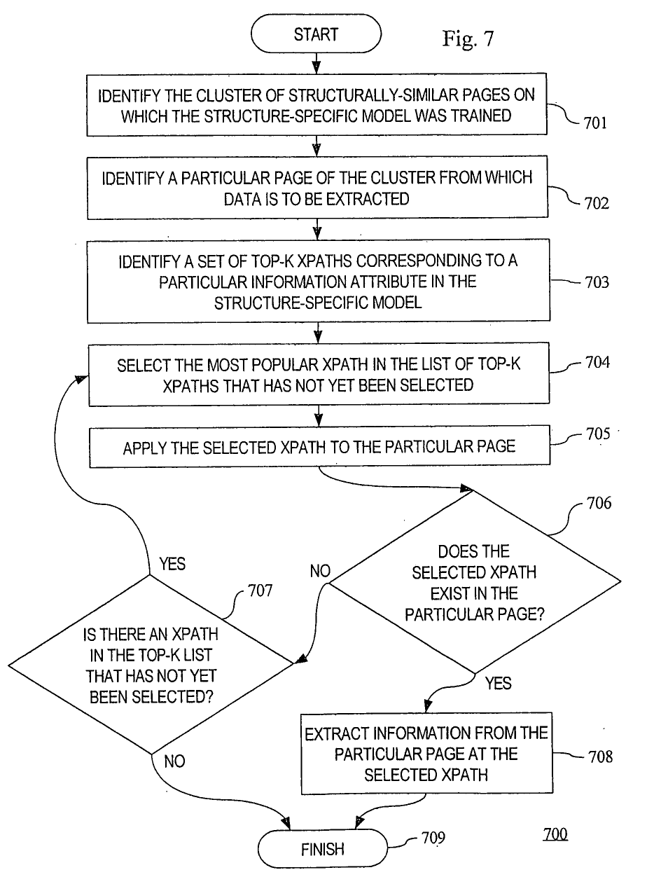

In one embodiment of the invention, a structure-specific model is used to extract information attributes from the pages of the cluster on which the structure-specific model was trained. In order to do so, the cluster of structurally similar pages on which the model was trained is identified, step 701 of FIG. 7. A particular page from which information is to be extracted is identified out of the cluster, step 702. As previously described, the structure-specific model has a set of top-K XPaths for each attribute in the sample of pages from the cluster. Thus, to extract a particular information attribute from the identified page of the cluster, the set of top-K XPaths corresponding to the particular information attribute is identified, step 703, and applied to the particular page. The XPath from the list of top-K XPaths that occurred most often in the sample set is applied to the identified page first, steps 704-705. If the most popular XPath is unsuccessful at extracting the particular attribute, then the next most popular XPath is applied to the particular page, and so on, steps 704-707. In one embodiment of the invention, if the particular attribute is found in a page using one of the top-K XPaths, then that information is output as the extracted information, steps 706 and 708. If application of the top-K XPaths does not result in extracted information, then it is assumed that the particular attribute is not present on the particular page, steps 707 and 709. In one embodiment of the invention, an XPath is applied to a particular page by determining the DOM tree of the page and using the XPath as an index into the DOM tree. The information found at the node or subtree that the XPath indexes is extracted by the IE system.

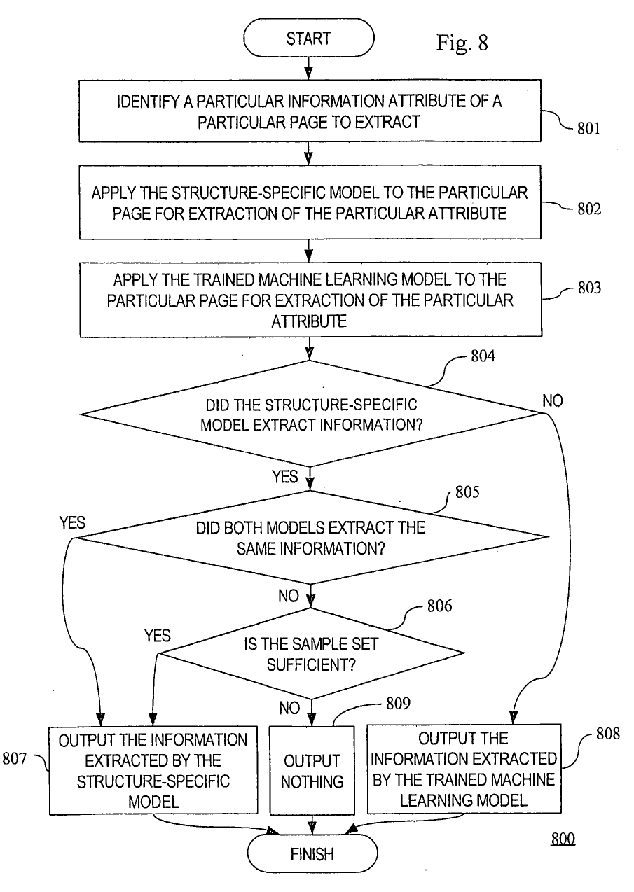

In another embodiment of the invention, extraction of a particular attribute from a particular page is performed by combining the output of the structure-specific model and an output of the trained machine learning model relative to the particular attribute. For example, as illustrated in FIG. 8, a particular information attribute of a particular page is identified for extraction, step 801. The structure-specific model is applied to the page for extraction of the particular attribute, step 802. The trained machine learning model is also applied to the particular page for extraction of the particular attribute, step 803. If the structure-specific model does not find information in the page to extract for the particular attribute, step 804, then the information extracted by the trained machine learning model is output, step 808. The structure-specific model may fail to extract information because the structure-specific model is inflexible due to the fact that the model consists of fixed sets of XPaths derived from the sample set. If the sample set is insufficient, i.e., the pages of the sample set are not structurally representative of the pages of the cluster, then the structure-specific model does not have sufficient information to extract information attributes from the pages of the cluster, especially with respect to the attributes in which the sample set is deficient. In contrast, the trained machine learning model is flexible and is trained to extract information from a variety of document structures. In this embodiment of the invention, it is assumed that the precision of the trained machine learning model is satisfactory.

In yet another embodiment of the invention, if both models extract the same information, step 805, then that information is output as the extracted information, step 807. In yet another embodiment of the invention, if the outputs of both models are not the same, then the sufficiency of the sample set is considered, step 806. If the sample set is sufficiently representative of the cluster, then the information extracted by the structure-specific model is output, step 807. If the sample set is considered insufficient, then no information is extracted from the page for the particular attribute, step 809, because outputting information would likely affect precision. A sample set for a cluster of structurally similar pages is sufficiently representative of the cluster if the structures found in the sample are representative of the structures found in the pages of the cluster as a whole. For example, each page of a particular cluster has an instance of an “image” attribute. In 50% of the pages of the cluster, the value for the image attribute is found at XPath_l, in 40% of the pages, the value for the image attribute is found at XPath_2, and in 10% of the pages, the value for the image is found at XPath_3. A sample that is perfectly representative of that cluster with respect to the “image” attribute will represent all three XPaths in the same proportion as the cluster. A sample may be considered sufficiently representative if the sample is closely representative of the cluster to which the sample pertains, above a specified threshold. However, a sample that omits structures or seriously skews, beyond a specified threshold, the proportion of structures present in the cluster may be considered insufficient. Furthermore, a sample may be considered sufficient if the number of pages in the sample is over a pre-defined threshold, i.e., more than 20% of the documents in the cluster are in the sample. A person of ordinary skill in the art will understand that a sample of pages from a cluster may include all of the pages in the cluster, or any subset thereof, and may be increased or decreased according to need at any time during the process.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

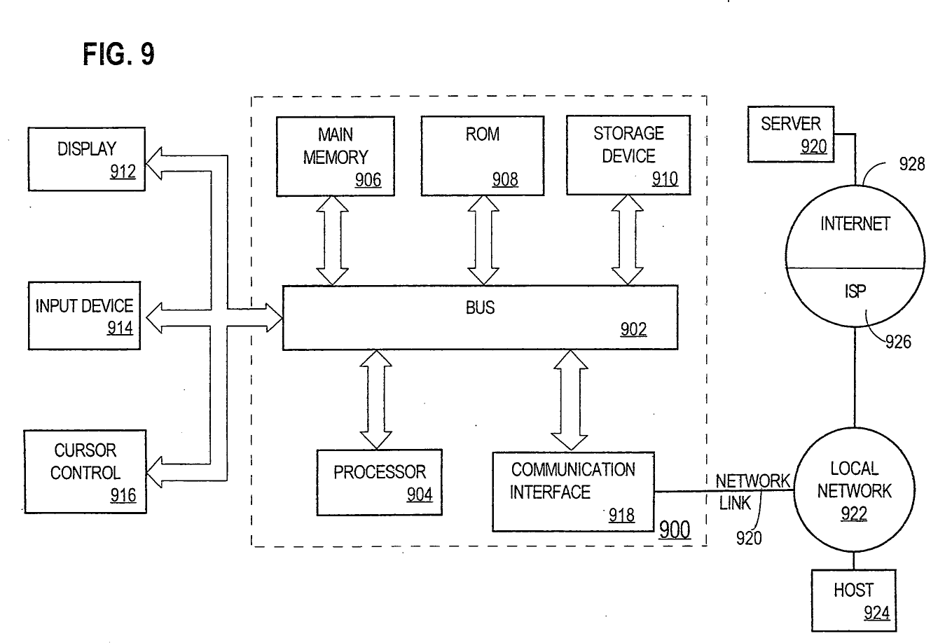

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
producing a trained machine learning model based at least in part on a plurality of documents;
applying the trained machine learning model to a set of documents;
based at least in part on the applying the trained machine learning model to the set of documents, determining a plurality of locations of a particular attribute in the set of documents;
associating a set of locations with the particular attribute, based at least in part on the plurality of locations; and
based at least in part on the set of locations, extracting, from a particular document, an attribute value corresponding to the particular attribute;
wherein the method is performed by one or more computing devices programmed to be special purpose machines pursuant to program instructions.

2. The computer-implemented method of claim 1,
wherein each document of the set of documents is structurally similar to each document of the balance of documents in the set of documents; and
wherein the particular document is structurally similar to each document of the set of documents.

3. The computer-implemented method of claim 1,
wherein the trained machine learning model is at least one of (a) Conditional Random Field-based or (b) Hidden Markov model-based; and
wherein the trained machine learning model has 50% or greater precision.

4. The computer-implemented method of claim 1, wherein a particular location of the set of locations comprises an XPath corresponding to at least one of (a) a leaf node of a Document Object Model (DOM) tree, and (b) a subtree of a Document Object Model (DOM) tree.

5. The computer-implemented method of claim 1, wherein associating the set of locations with the particular attribute further comprises:
determining a second set of locations comprising the locations included in the plurality of locations that are not included in the set of locations;
determining a first set of frequencies comprising a frequency with which each location in the set of locations occurs in the set of documents;
determining an aggregate frequency based at least in part on adding together each frequency of the first set of frequencies;
determining whether the aggregate frequency is above a pre-defined threshold;
wherein the pre-defined threshold is 90%; and
in response to determining that the aggregate frequency is not above the pre-defined threshold:
determining a second set of frequencies comprising a frequency with which each location in the second set of locations occurs in the set of documents;
identifying a particular location of the second set of locations having a highest frequency of the second set of frequencies; and
including the particular location in the set of locations.

6. The computer-implemented method of claim 1, wherein associating a set of locations with the particular attribute further comprises:
determining whether a frequency with which a particular location occurs in the set of documents is above a pre-defined threshold; and
in response to determining that the frequency is above the pre-defined threshold, including the particular location in the set of locations.

7. The computer-implemented method of claim 1, wherein extracting an attribute value corresponding to the particular attribute from a particular document based at least in part on the set of locations further comprises:
determining a particular location of the particular attribute in the particular document based at least in part on the set of locations; and
extracting the attribute value from the particular location in the particular document.

8. The computer-implemented method of claim 1, wherein extracting an attribute value corresponding to the particular attribute from a particular document based at least in part on the set of locations further comprises:
determining a first attribute value of the particular attribute based on applying the trained machine learning model to the particular document;
determining a second attribute value of the particular attribute based on the set of locations;
determining whether the first attribute value and the second attribute value are the same;
in response to determining that the first attribute value and the second attribute value are not the same, determining whether the set of documents is sufficiently representative of the particular document; and
in response to determining that the set of documents is sufficiently representative of the particular document, extracting the second attribute value.

9. The computer-implemented method of claim 1, wherein extracting an attribute value corresponding to the particular attribute from a particular document based at least in part on the set of locations further comprises:
determining a first attribute value of the particular attribute based on applying the trained machine learning model to the particular document;
determining a second attribute value of the particular attribute based on the set of locations;
determining whether the first attribute value and the second attribute value are the same;
in response to determining that the first attribute value and the second attribute value are not the same, determining whether the set of documents is sufficiently representative of the particular document; and
in response to determining that the set of documents is not sufficiently representative of the particular document, extracting no value.

10. The computer-implemented method of claim 1,
wherein applying the trained machine learning model to a set of documents further comprises extracting an attribute value for the particular attribute from a particular document of the set of documents; and
wherein determining the plurality of locations of the particular attribute in each document of the set of documents further comprises:
determining a location of the attribute value in a DOM tree of the particular document; and
including the location in the plurality of locations.

11. One or more storage media storing instructions which, when executed by one or more computing devices, cause performance of the method recited in claim 1.

12. One or more storage media storing instructions which, when executed by one or more computing devices, cause performance of the method recited in claim 2.

13. One or more storage media storing instructions which, when executed by one or more computing devices, cause performance of the method recited in claim 3.

14. One or more storage media storing instructions which, when executed by one or more computing devices, cause performance of the method recited in claim 4.

15. One or more storage media storing instructions which, when executed by one or more computing devices, cause performance of the method recited in claim 5.

16. One or more storage media storing instructions which, when executed by one or more computing devices, cause performance of the method recited in claim 6.

17. One or more storage media storing instructions which, when executed by one or more computing devices, cause performance of the method recited in claim 7.

18. One or more storage media storing instructions which, when executed by one or more computing devices, cause performance of the method recited in claim 8.

19. One or more storage media storing instructions which, when executed by one or more computing devices, cause performance of the method recited in claim 9.

20. One or more storage media storing instructions which, when executed by one or more computing devices, cause performance of the method recited in claim 10.
